(19) United States
(12) Patent Application Publication
(10) Pub. No.: US 2019/0243180 A1
(43) Pub. Date: Aug. 8, 2019

(54) DISPLAY DEVICE

(71) Applicant: SHARP KABUSHIKI KAISHA, Sakai City (JP)

(72) Inventor: JIN NAKAMURA, Sakai City (JP)

(73) Assignees: SHARP KABUSHIKI KAISHA, Sakai City, Osaka (JP); SHARP KABUSHIKI KAISHA, Sakai City, Osaka (JP)

(21) Appl. No.: 16/210,980

(22) Filed: Dec. 5, 2018

(30) Foreign Application Priority Data
Feb. 2, 2018 (JP) 2018-017484

(51) Int. Cl. G02F 1/1347; G02F 1/1333; G02F 1/1345

(52) U.S. Cl. CPC G02F 1/13471; G02F 1/1345; G02F 1/133308

(57) ABSTRACT

The present invention allows a display device having a see-through panel structure to achieve an increased optical transmittance at a point in time when light reaches an imaging element. A display device (2) has a see-through panel structure and includes: a display panel (DP); an imaging element (FD) provided on a back surface side of the display panel; and a liquid transparent resin (13) filled into a space between the display panel and the imaging element.

This Nonprovisional application claims priority under U.S.C. § 119 on Patent Application No. 2018-017484 filed in Japan on Feb. 2, 2018, the entire contents of which is hereby incorporated by reference.

### TECHNICAL FIELD

The present invention relates to a display device.

### BACKGROUND ART

A display device which includes an imaging element, such as a camera, in a frame (non-display area) surrounding a display area is known in the art. In addition, a display device having a see-through panel structure within a display area is known in the art. The see-through panel structure is a structure in which, in a display device, a display panel including a first substrate has a light transmitting part (see-through hole part) characterized as maximizing a transmittance, wherein the light transmitting part includes a liquid crystal layer but differs from a typical liquid crystal display region in that materials which can block the transmission of light (metallic wiring, ITO wiring, insulating film, BM, a coloring material, etc.) are reduced from the layers in the light transmitting part according to uses of the display device, and wherein the light transmitting part contains a part of a region of the first substrate. In the display device having such a see-through panel structure, the imaging element captures an image of a photographic subject in a state in which the display panel is present in front of the imaging element. Thus, the amount of light reaching the imaging element decreases.

### CITATION LIST

### Patent Literatures

### Patent Literature 1

Japanese Patent No. 4886462

### Patent Literature 2

Japanese Patent Application Publication Tokukai No. 2008-257191

### SUMMARY OF INVENTION

### Technical Problem

The decrease in light amount associated with the see-through panel structure results mainly from the impact of films formed on surfaces of TFTs which films face the imaging element. The see-through panel structure leads to an inevitable decrease in optical transmittance in comparison to the structure known in the art in which only a cover glass (protection plate) is present in front of the imaging element.

It is an object of the above aspect of the present invention to allow the display device having a see-through panel structure to achieve an increased optical transmittance at a point in time when light reaches the imaging element.

### Solution to Problem

In order to solve the above problem, a display device in accordance with an aspect of the present invention is a display device having a see-through panel structure, including: a display panel; an imaging element provided on a back surface side of the display panel; and a transparent material filled into a space between the display panel and the imaging element.

### Advantageous Effects of Invention

The above aspect of the present invention allows the display device having a see-through panel structure to achieve an increased optical transmittance at a point in time when light reaches the imaging element.

### BRIEF DESCRIPTION OF DRAWINGS

FIG. 1 is a plan view illustrating the configuration of a display device in accordance with Embodiment 1 of the present invention.

FIG. 2 is a cross-sectional view illustrating the configuration of the display device in accordance with Embodiment 1 of the present invention.

FIG. 3 is a view illustrating a liquid transparent resin and an imaging element in accordance with Embodiment 1 of the present invention.

FIG. 4 is a view illustrating the effect of Embodiment 1 of the present invention.

FIG. 5 is a view illustrating a transparent resin tape and an imaging element in accordance with Embodiment 2 of the present invention.

FIG. 6 is a view illustrating a transparent resin tape and an imaging element FD in accordance with Embodiment 3 of the present invention.

### DESCRIPTION OF EMBODIMENTS

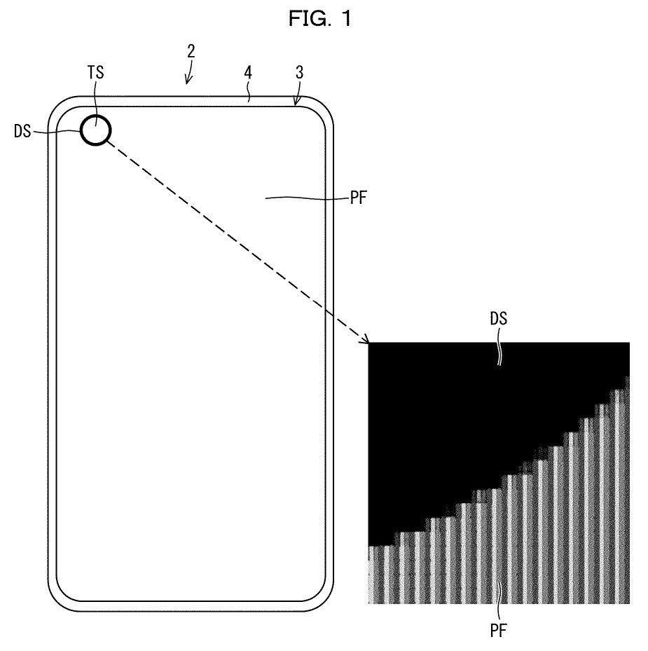

The following description will discuss embodiments of the present invention with reference to FIGS. 1 to 6. Note, however, that those embodiments are only illustrative.

### Embodiment 1

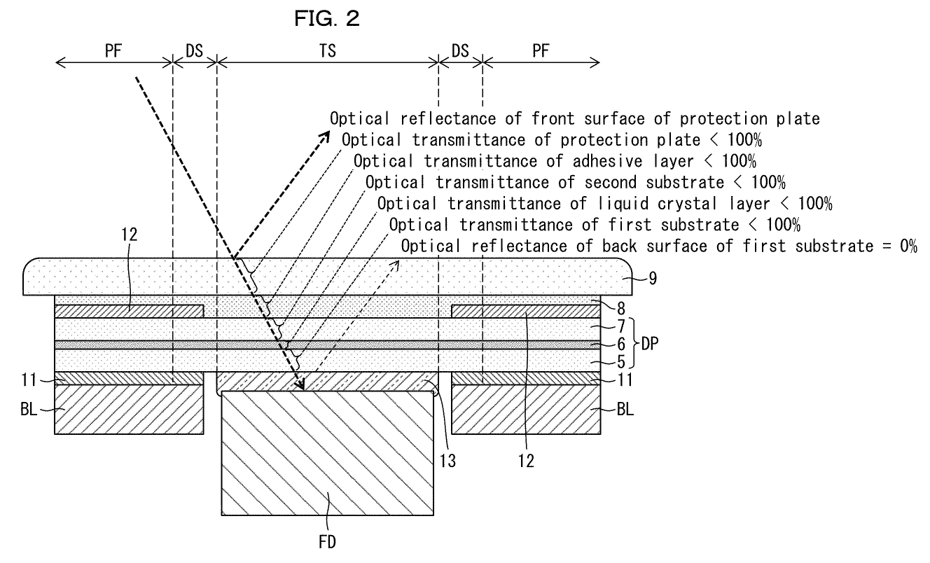

FIG. 1 is a plan view illustrating the configuration of a display device 2 in accordance with Embodiment 1 of the present invention. FIG. 2 is a cross-sectional view illustrating the configuration of the display device 2 in accordance with Embodiment 1 of the present invention.

(Display Device 2)

As illustrated in FIGS. 1 and 2, the display device 2 (e.g., a smart phone) in accordance with Embodiment 1 of the present invention has the see-through panel structure. The display device 2 includes: a backlight unit BL; an imaging element FD (including a lens); a display panel DP (liquid crystal panel); a first polarization plate 11 and a second polarization plate 12 between which the display panel DP is provided; and a protection plate 9 (cover glass) which is bonded to the second polarization plate 12 via a light-transmitting adhesive layer 8. The imaging element FD is provided on a back surface side of the display panel DP.

The display panel DP includes a first substrate 5 (active matrix substrate), a liquid crystal layer 6, and a second substrate 7 (counter substrate, color filter substrate) including primary color filters. The display device 2 is configured such that the backlight unit BL, the first polarization plate 11, the first substrate 5, the liquid crystal layer 6, the second substrate 7, the second polarization plate 12, the adhesive layer 8, and the protection plate 9 are disposed in this order in an upward direction (in a direction in which display light exits).

As illustrated in FIG. 1, the display panel DP includes: a light transmitting part TS (e.g., a see-through camera hole) from which no display light exits; and a light blocking part DS which surrounds the light transmitting part TS. The light transmitting part TS is provided in a display area 3 so as to be located inside the edge of the display area 3. The light blocking part DS is surrounded by an image forming part PF. The display light is light which is generated by pixels (not illustrated) and corresponds to image data. The light transmitting part TS does not include the pixels. The light transmitting part TS has a planar surface whose shape is determined by, for example, characteristics of the imaging element FD. It is desirable that the shape of the planar surface is designed in consideration of lens characteristics, such as the shape of the lens, and an angle at which light enters the lens.

As illustrated in FIG. 2, assuming that the protection plate 9, the adhesive layer 8, the second substrate 7, the liquid crystal layer 6, the first substrate 5, and a liquid transparent resin 13 are equal in refractive index, a transmittance at a point in time when light reaches the imaging element FD is determined by an optical reflectance of a front surface of the protection plate 9, an optical transmittance of the protection plate 9, an optical transmittance of the adhesive layer 8, an optical transmittance of the second substrate 7, an optical transmittance of the liquid crystal layer 6, and an optical transmittance of the first substrate 5. Note that the filling of the liquid transparent resin 13 allows the back surface of the first substrate 5 to have an optical reflectance of 0%.

(Liquid Transparent Resin 13)

The liquid transparent resin (transparent material) 13 is filled into a space between the display panel DP and the imaging element FD. In Embodiment 1, the display panel DP and the imaging element FD are fixed with use of the liquid transparent resin 13 to prevent light from being reflected by the back surface of the first substrate 5. It is important that a structure in which no air layer is present between the display panel DP and the imaging element FD is provided by bonding the display panel DP and the imaging element FD together.

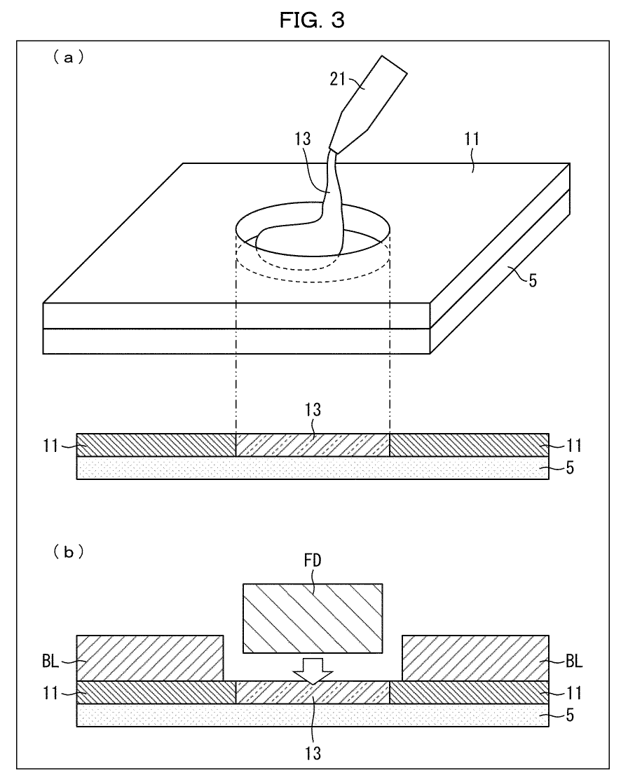

FIG. 3 is a view illustrating the liquid transparent resin 13 and the imaging element FD in accordance with Embodiment 1 of the present invention. (a) of FIG. 3 is a view illustrating the manner of filling the liquid transparent resin 13. (b) of FIG. 3 is a view illustrating the manner of bonding the imaging element FD.

As illustrated in (a) of FIG. 3, a hole of the first polarization plate 11 is coated and filled with the liquid transparent resin 13 for bonding through, for example, a nozzle of a liquid determining and charging device 21 (dispenser). Subsequently, as illustrated in (b) of FIG. 3, the imaging element FD is bonded to the liquid transparent resin 13 in such a manner that the imaging element FD is put on a surface of the liquid transparent resin 13. That is, the liquid transparent resin 13 is injected into a space between the display panel DP and the imaging element FD. Thereafter, the liquid transparent resin 13 is cured by, for example, irradiation with ultraviolet light.

### Effects of Embodiment 1

According to the display device 2 in accordance with Embodiment 1, the display panel DP and the imaging element FD are bonded with the liquid transparent resin 13 to eliminate an air layer between the display panel DP and the imaging element FD. Such a configuration allows for reduction of the amount of light reflected by an air layer, which greatly differs in refractive index from glass, at the incidence on the air layer.

As a whole, no air layer is present between the front surface of the protection plate 9 and a camera lens glass of the imaging element FD. This means that there is little difference in photorefractive index between the layers provided between the protection plate 9 and the imaging element FD. This reduces unnecessary loss of light and thus achieves an increased optical transmittance at a point in time when light reaches the imaging element FD.

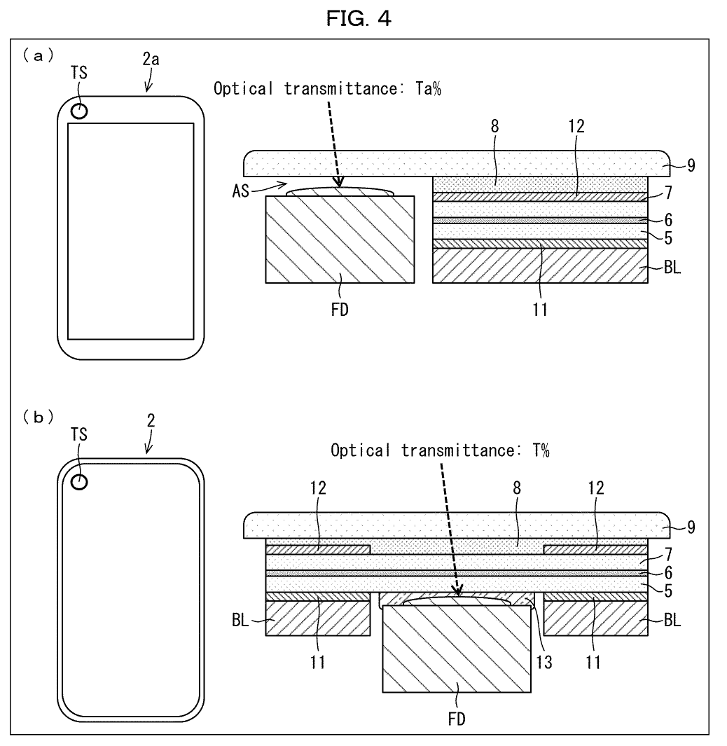

FIG. 4 is a view illustrating the effect of Embodiment 1 of the present invention. (a) of FIG. 4 is a view illustrating the configuration of a display device 2a known in the art. (b) of FIG. 4 is a view illustrating the configuration of the display device 2 in accordance with Embodiment 1 of the present invention.

As illustrated in (a) of FIG. 4, the display device 2a known in the art is configured such that the imaging element FD directly faces the back surface of the protection plate 9 and captures an image of a photographic subject in a state in which the protection plate 9 and air space AS (air layer) are present in front of the imaging element FD. Assume that an optical transmittance of the protection plate 9 is Ta [%].

As illustrated in (b) of FIG. 4, since the display device in accordance with Embodiment 1 of the present invention has a see-through panel structure, the display device 2 inevitably suffers from a decrease in optical transmittance T [%] at a point in time when light reaches the imaging element FD. However, the structure in which no air layer is present between the display panel DP and the imaging element FD allows the display device 2 to have the optical transmittance T which is comparable to the optical transmittance Ta of the display device 2a known in the art in which the imaging element FD is provided so as to directly face the back surface of the protection plate 9. This is effective at performing image capture with use of the imaging element FD.

### Embodiment 2

The following will describe Embodiment 2 of the present invention. For convenience of description, any members of Embodiment 2 that are identical in function to the members described for Embodiment 1 are assigned the same reference signs, and are not described again here. The transparent material in accordance with Embodiment 1 is the liquid transparent resin 13, whereas a transparent material in accordance with Embodiment 2 is a seal-type transparent resin tape 13a.

(Transparent Resin Tape 13a)

The transparent resin tape (transparent material) 13a in accordance with Embodiment 2 is filled into a space between a display panel DP and an imaging element FD.

In such a case, the transparent resin tape 13a which fits a hole of a first polarization plate 11 is fit into the hole of the first polarization plate 11, and the imaging element FD is bonded to a surface of the transparent resin tape 13a. Thereafter, the transparent resin tape 13a is cured by, for example, irradiation with ultraviolet light.

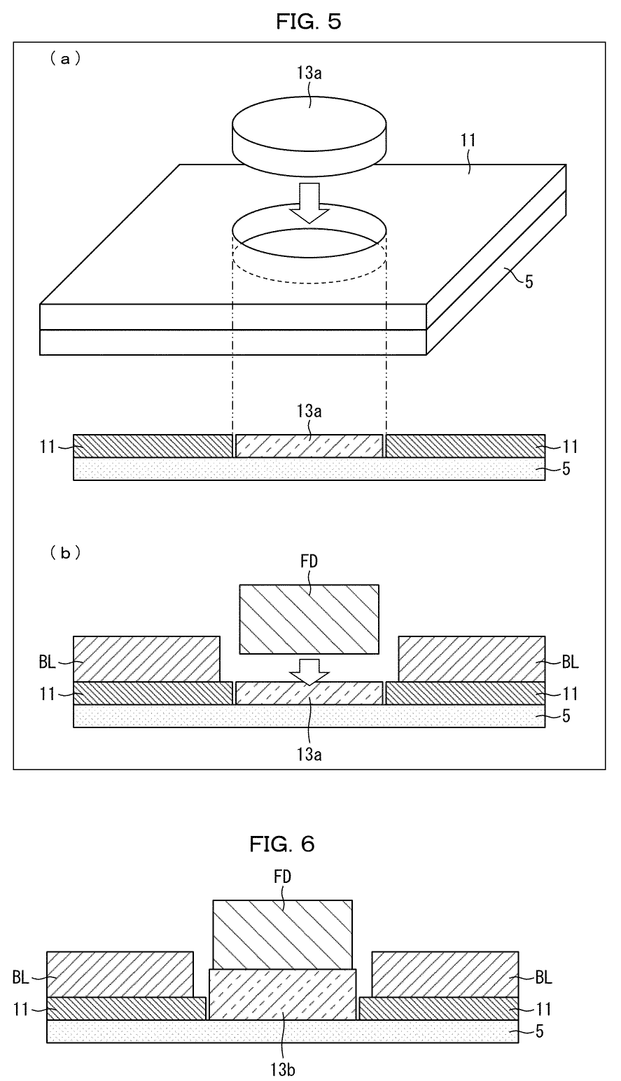

FIG. 5 is a view illustrating the transparent resin tape 13a and the imaging element FD in accordance with Embodiment 2 of the present invention. (a) of FIG. 5 is a view illustrating the manner of filling the liquid transparent resin tape 13a. (b) of FIG. 5 is a view illustrating the manner of bonding the imaging element FD.

As illustrated in (a) of FIG. 5, the transparent resin tape 13a for bonding is fit into a hole of a first polarization plate 11. As illustrated in (b) of FIG. 5, the imaging element FD is bonded to a surface of the transparent resin tape 13a in such a manner that the imaging element FD is put on the surface of the transparent resin tape 13a. Thereafter, the transparent resin tape 13a is cured by, for example, irradiation with ultraviolet light.

### Effect of Embodiment 2

According to the display device 2 in accordance with Embodiment 2, Embodiment 2 yields an effect which is similar to the effect of Embodiment 1. Specifically, the display device 2 having the see-through panel structure achieves an increased optical transmittance at a point in time when light reaches the imaging element FD. Further, the use of the transparent resin tape 13a allows the display panel DP and the imaging element FD to be bonded together easily.

### Embodiment 3

The following will describe Embodiment 3 of the present invention. For convenience of description, any members of Embodiment 3 that are identical in function to the members described for Embodiments 1 and 2 are assigned the same reference signs, and are not described again here. The transparent material in accordance with Embodiment 3 is a seal-type transparent resin tape 13b.

### (Transparent Resin Tape 13b)

The transparent resin tape (transparent material) 13b in accordance with Embodiment 3 is filled into a space between a display panel DP and an imaging element FD.

In such a case, the transparent resin tape 13b which fits a hole of the first polarization plate 11 is fit into the hole of the first polarization plate 11, and the imaging element FD is bonded to a surface of the transparent resin tape 13b. Thereafter, the transparent resin tape 13b is cured by, for example, irradiation with ultraviolet light.

FIG. 6 is a view illustrating the transparent resin tape 13b and the imaging element FD in accordance with Embodiment 3 of the present invention. As illustrated in FIG. 6, the display device 2 further includes a first polarization plate (polarization plate) 11 which is provided on a back surface side of a display panel DP, and the transparent resin tape 13b which is greater in thickness than the first polarization plate 11 is used as a transparent material.

That is, the thickness of the transparent resin tape 13b is not necessarily made equal to the thickness (height) of the first polarization plate 11, and can be greater than the thickness of the first polarization plate 11.

### Effect of Embodiment 3

According to the display device 2 in accordance with Embodiment 3, Embodiment 3 yields an effect which is similar to the effect of Embodiment 1. Specifically, the display device 2 having the see-through panel structure achieves an increased optical transmittance at a point in time when light reaches the imaging element FD. Further, the use of the transparent resin tape 13b allows the display panel DP and the imaging element FD to be bonded together easily.

The present invention is not limited to the embodiments, but the present invention also encompasses, in its technical scope, any embodiment derived by combining technical means disclosed in differing embodiments. Further, it is possible to form a new technical feature by combining the technical means disclosed in the respective embodiments.

[Aspect 1]

A display device having a see-through panel structure, including: a display panel; an imaging element provided on a back surface side of the display panel; and a transparent material filled into a space between the display panel and the imaging element.

[Aspect 2]

The display device according to, for example, Aspect 1, wherein the transparent material is a liquid transparent resin injected into the space between the display panel and the imaging element.

[Aspect 3]

The display device according to, for example, Aspect 1, wherein the transparent material is a transparent resin tape.

[Aspect 4]

The display device according to, for example, Aspect 3, further including:

a polarization plate provided on the back surface side of the display panel,

the transparent material being a transparent resin tape which is greater in thickness than the polarization plate.

[Aspect 5]

The display device according to, for example, any one of Aspects 2 to 4, wherein the transparent material is cured with ultraviolet light.

### REFERENCE SIGNS LIST

2: Display device
11: First polarization plate (polarization plate)
13: Liquid transparent resin (transparent material)
13a: Transparent resin tape (transparent material)
13b: Transparent resin tape (transparent material)
DP: Display panel
FD: Imaging element

1. A display device having a see-through panel structure, comprising:
a display panel;
an imaging element provided on a back surface side of the display panel; and
a transparent material filled into a space between the display panel and the imaging element.

2. The display device according to claim 1, wherein the transparent material is a liquid transparent resin injected into the space between the display panel and the imaging element.

3. The display device according to claim 1, wherein the transparent material is a transparent resin tape.

4. The display device according to claim 3, further comprising:
a polarization plate provided on the back surface side of the display panel,
the transparent material being a transparent resin tape which is greater in thickness than the polarization plate.

5. The display device according to claim 2, wherein the transparent material is cured with ultraviolet light.
